(19) United States
(12) Patent Application Publication
(10) Pub. No.: US 2006/0289525 A1
(43) Pub. Date: Dec. 28, 2006

(54) Microwave leakage indicator card

(76) Inventor: George B. Hovorka, East Boston, MA (US)

Correspondence Address: George B. Hovorka;Idolon Techologies, 72 Stone Place, Melrose, MA, 02176, US

(21) Appl. No.: 11/377,782

(22) Filed: Mar. 16, 2006

Related U.S. Application Data
(60) Provisional application No. 60/662,781, filed on Mar. 17, 2005.

(51) Int. Cl. H05B 6/76

(52) U.S. Cl. 219/737

(57) ABSTRACT

The present invention discloses a microwave oven leakage detector comprising: a) A support member. b) An antenna formed on said support layer that has a region of resistive coating capable of being heated by microwave radiation due to current flow through said antenna which includes said resistive region. c) A temperature sensitive color indicator layer in thermal contact with said resistive region, characterized in that the antenna layer has i.) Is able to effectively collect the microwave radiation leakage from said microwave oven to result in current flow which in turn causes localized heating in its resistive region and ii.) Sufficient heat generating capacity of the resistive region to affect a change in the temperature sensitive, color change indicator layer.

### CROSS REFERENCES TO RELATED APPLICATIONS

This invention is related complimentary to the invention of my provisional application Ser. No. 60/662,781 filed Mar. 17, 2005.

### BACKGROUND

1. Field of Invention

The present invention relates in general to devices for the detection of radio frequency radiation, and more particularly to a test card for the detection of excess radiation leakage from microwave ovens.

2. Description of Prior Art

Although manufacturers of microwave ovens carefully design ovens to protect the user from exposure to microwave energy, all microwave ovens can and do leak some radiation. Leakage is particularly prevalent around the door seal and window, however some amount of radiation is legally allowed to and does escape through shielding around the cooking cavity. Therefore all microwave ovens leak some radiation and in many, the level of radiation leakage increases over time due to the aging of the door seal gasket due to the accumulation of spilled food particles. Also door hinge and latch wear can result in additional leakage. Therefore to protect the user, the Bureau of Radiological Health, Department of Heath and Education and Welfare has specified a maximum allowable leakage level of 5 milliwatts per square centimeter measured 5 centimeters away from any oven surface as described in the Radiation Control for Health and Safety Act of 1968, Section 1030.10. More recently, the medical and scientific literature indicates that the leakage level that was set in 1968 is too high in view of deleterious health effects from low level microwave radiation. With over 200 million microwave ovens in operation around the world, there is a need for a simple and accurate device to detect radiation leakage occurring at low levels and to provide a reliable reading of excess microwave radiation leakage.

Recently, the microwave oven frequency, which is in the center of the 2.4 to 2.5 GHz Industrial, Scientific and Medical (ISM) band, has become widely utilized in other technologies such as cordless phones, and wireless local area networks (WLANs). As a result, the radiation leakage emanating from a microwave oven's leaky door seals and the like can create network disruption problems. This leakage noise is periodic, locked to the power line frequency. A legal microwave oven has a radiated output power approximately 20 dB greater in signal strength than that allowed by the FCC for operation under Part 15 of FCC rules and regulations for non-spread-spectrum radios. A legal microwave oven emits enough leakage such that several network error correction patents have issued to attempt to deal with the problem. Examples of this patent art include U.S. Pat. No. 6,006,071, Roberts, Dec. 21, 1999, and U.S. Pat. No. 6,374,082, Carlson, Apr. 16, 2002. However, a microwave oven with a leaky door seal or hinge can completely disrupt network communications or cordless phone operation even when very sophisticated error correcting methods are utilized. This is because these error-correcting schemes mitigate the problem by utilizing the fact that the microwave noise is locked to the line frequency. Such schemes are of no use for hand-held devices such as cordless phones or Bluetooth wireless devices, neither of which have direct line connection. Also if the microwave oven that is leaking radiation is connected to a different phase of the building's power system, such correction schemes are of no use. The only solution to such interference problems is to determine which microwave oven is causing the leakage by utilizing a radiation sensor, and either repairing the leak or taking the unit out of service. Therefore there is a need for a simple and accurate radiation leakage sensor, not only for protecting the user, but also to protect networks and communications schemes that share the same ISM frequency band as microwave ovens.

Devices for this purpose are presently available in two general types: electronic and thermal. The electronic devices employ an antenna, which senses the radiation and converts it into a high frequency current, which is then rectified and measured as direct current by means of a current meter. In an alternate configuration, the high frequency current from the antenna is passed through a resistive element, which is mechanically coupled to a highly sensitive electronic temperature measuring means such as a thermistor or thermocouple. This device creates an electrical signal, which is then amplified and processed into a useable output. Each of these two electronic approaches utilizes an antenna to detect the microwave energy, which is then measured by means of sophisticated circuitry. Due to the high cost of such electronic radiation leakage detectors, ranging from $30 to several thousand dollars, the need has arisen for a very low cost detector that can be used to check commercially available microwave ovens for leakage. Such devices, which are known as thermal detectors, change their color in the presence of microwave energy. An early example is the invention by Fanslow, U.S. Pat. No. 4,051,435, Sep. 27, 1977. These color-changing indicators are based on the principle of placing an RF-absorbing substance, such as carbon, ferrite, or a metal coating, in direct contact with a thermal sensing liquid crystal (LC) material. When the microwave field from a leaking oven door seal is in contact with this composite structure, the RF absorbent material will generate a very small amount of heat, which will vary dependent on the field intensity. This heat flux is then imposed on the adjacent liquid crystals through thermal transfer. Since the liquid crystals assume particular colors in accordance with the temperature of the crystals, they will respond chromatically to the incident microwave energy level. While such thermal detectors have attained the cost objective, they have several drawbacks, which have limited their commercial acceptance. These drawbacks are centered on the basic measurement principle in which the microwave absorptive material is supposed to create sufficient heat to create a discernible change in the LC color indicator. Due to the small capture area of these absorptive particles in the incident beam, the amount of heating is very small. Therefore special insulating mechanisms have been taught to protect the sensor from variation in room ambient temperatures, which tends to drown out the desired response. This is taught in U.S. Pat. No. 4,051,435. The method disclosed in U.S. Pat. No. 5,370,841, McDonnell, Dec. 6, 1994, teaches a microwave oven leakage detector based on a similar method except the amount of absorptive material has been varied in separate cells of LC material in an attempt to create a more discernible indicator. Other thermal microwave oven leakage detectors include U.S. Pat. No. 4,065,665, Wong, Dec. 27, 1977, and U.S. Pat. No. 4,467,278, Toth, Aug. 21, 1984. These approaches have not been particularly effective. Even with the thermal insulation, changes in ambient temperature affect the microwave signal and the addition of more absorptive material displaces the LC material such that any color change is hard to see. Previous prior art designs are generally not useable when the ambient temperature is above 85 degrees Fahrenheit which can easly occur in a kitchen particulary those in southern climates. In addition, prior art designs suffered from poor sensitivity limited to 1 mW/cm². Moreover, since the use of these LC-based products requires the user to be able to discern small differences in color, colorblind individuals, who comprise 8.4% of the population, are unable to see the color indication and are thus unable to use the product. Thus there is the need for a low cost device suitable for sensing and measuring the leakage of microwave radiation from a microwave oven door seal which has the following attributes: 1) Can sense microwave energy at very low levels down to 0.5 mW/cm² because: a) Recent medical research has indicated the dangers of low level exposure. b) The new communication uses for the 2.54 GHz ISM band in which an oven that leaks a small amount microwave radiation can cause network disruption. 2) Should be designed such that changes in ambient temperature do not affect the results. 3) Should provide a clear monochromatic, visual indication. 4) Should provide a fast response. 5) Must be rugged, self-contained, and require no external power source. The present application makes use of an antenna means to concentrate the leakage energy to provide a level of sensitivity and independence from the effects of ambient temperature previously not possible for low cost thermal microwave oven leakage detectors.

### BRIEF DESCRIPTION OF THE DRAWINGS

The invention will now be described, by way of example, with reference to the accompanying drawings, in which:

FIG. 1 is a plan view of a preferred embodiment of the present invention.

FIG. 2 is an enlarged side elevation view, taken generally along lines 2-2 of FIG. 1 with the resistive area cool.

FIG. 3 is an enlarged side elevation view, taken generally along lines 2-2 of FIG. 1 with the resistive area hot.

FIG. 4 is an enlarged plan view of the thermal sensor 15.

FIG. 5 is a plan view of Other Embodiments Example 1 of the current invention.

### SUMMARY

In accordance with the present invention, a self-contained portable device for sensing and measuring the electric field strength of microwave radiation emanating from a surface that is being tested is comprised of an antenna which narrows down to a narrow width in one place to form a resistive heating element. This antenna acts as an energy concentrating means such that significantly greater sensitivity than that of prior art thermal detectors is attained. This antenna may either be resonant, or a broadband antenna. Over the resistive area of the antenna this device further includes thermochromic ink which will change from black to white under the influence of the heating provided by the resistive area. This area in turn becomes hot in response to the flow of RF current through the antenna due to microwave energy. The result is a distinct white line against a black background, which can easily be discerned including by those who are colorblind. The device further includes a substrate upon which the antenna and thermochromic indicator are mounted to form a unitary package.

### Preferred Embodiment—Description

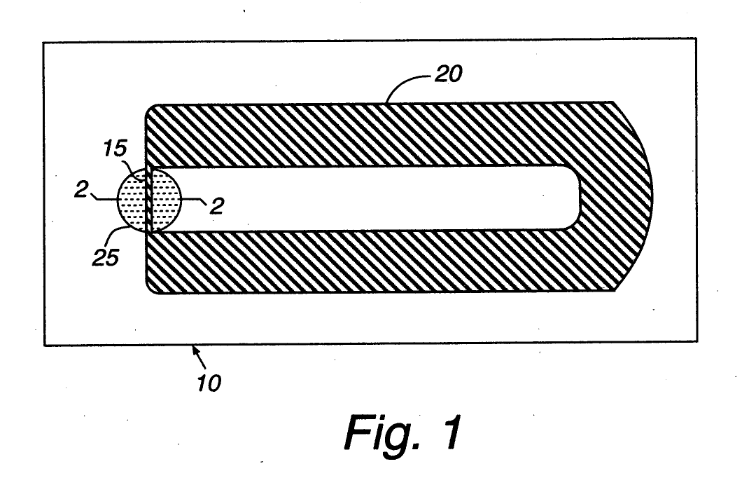

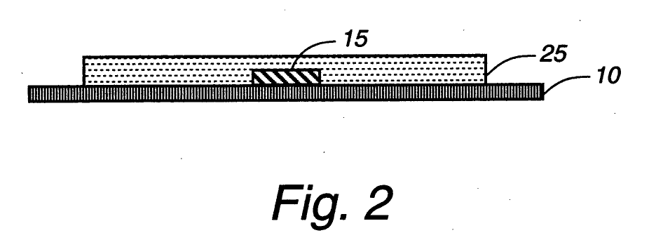

Referring to FIG. 1, there is shown a self-contained portable device mounted on a substrate 10 for sensing and measuring the electric field strength of microwave radiation emanating from the surface under test such as a microwave oven door seal. The preferred substrate 10 for the present invention is polystyrene 10 mils thick. The device includes an antenna 20, which is resonant at the 2.45 GHz microwave oven frequency. The loop is preferably formed from aluminized metal, which is affixed to the unitary package either by sputtering, or hot stamping. The preferred hot stamp foil is type SA88-210E manufactured by Crown Roll Leaf, Inc., Paterson, N.J. It is preferred that the loop be approximately ½ wavelength in circumference although other fractions of a wavelength such ¼ wavelength may be used with satisfactory results. The loop antenna 20 may be rectangular as shown, circular or irregular in shape so long as the area contained within the loop can be readily determined and it can be made to resonate at 2.45 GHz. The preferred width ratio between the wide part of the loop antenna and its narrow region, 15, which comprises the resistive area is 6:1. Referring to FIG. 2, the thermochromic ink 25 is positioned over the narrowed down portion of the antenna 15 such that it is in direct physical contact with the resistive area of the antenna. Matsui International Company, Inc. Chromicolor AQ-Ink Type #37 is preferred for this application. This particular ink remains black up to 37 degrees C., above which it turns white. Upon cooling, the ink returns to black in a reversible manner. The ink is applied by utilizing conventional silk screen means with a #80 mesh screen preferred.

### Preferred Embodiment—Operation

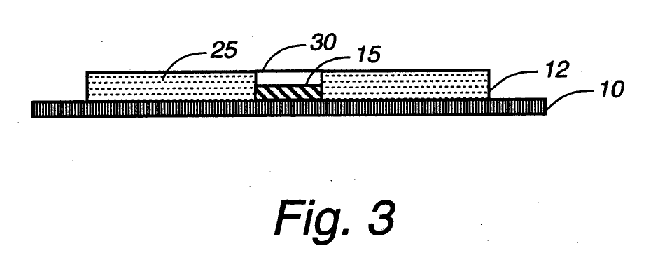

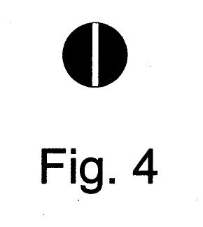

In order to measure the electric field strength of microwave radiation emanating from a surface being tested, the resonant loop antenna is moved over the region suspected of emitting microwave radiation with the antenna in close proximity to the suspected source. Referring to FIG. 3, current flow through the antenna causes the resistive area 15 to rise above the ambient temperature, which in turn causes the color of the thermochromic ink 30 situated over the resistive area 15 to change from black to white. Since the heat flow is able to rapidly change the color of the thermochromic ink over the resistive area while the adjacent areas remain black, the user sees a white line symbol against a black background as shown in FIG. 4.

To use the microwave oven leakage detector invention, a cup of water is placed in the oven and the oven is turned on at full power. The detector card is held on one corner to avoid de-tuning of the antenna by the user's hand and it is slowly moved around the periphery of the door. In this way, excess of leaking microwave radiation, if present, is collected by the antenna causing heating of the resistive area resulting in a color transition of the thermal chromic indicator situated over the resisitive area. Depending on the intended use, if high sensitivity is desired for example to detect weak microwave leakage affecting a WLAN network, the user slowly moves the detector around the periphery of the door for 60 seconds. Alternatively, if the user requires a less sensitive check to determine that the oven is meeting government standards, 15 seconds of testing is sufficient.

### Example 1

A microwave detector in accordance with the preferred embodiment of invention was prepared. This detector was used to detect leakage from a microwave oven (2,450 MHz) with an intentional leak that could be precisely controlled.

The latch mechanism of the oven was removed and it was replaced with a jack-screw such that the door could be slightly opened in a precise way. The switch interlock system of the oven was over ridden such that the oven would operate despite the slightly opened door. A 500 ml beaker of water was placed inside the oven and the door leak was adjusted to provide a leakage level of 0.5 mW/cm² as measured with a laboratory quality Broadband Isotropic Radiation Monitor (Narda Model 8300, Narda Microwave Corp. Plainview, N.Y.) and the room temperature was set to 68 degrees Fahrenheit. The detector card was attached to the microwave oven directly over the door seal leak with a double sided tape. The microwave oven was then turned on and a level of 0.5 mW/cm2 was observed with the Broadband Isotropic Radiation Monitor. The white line against the black circle symbol on the test card was developed after 30 seconds of exposure under these conditions.

The opening of the microwave door was then increased until the Broadband Isotropic Radiation Monitor indicated a 2 mW/cm² field. The white line against the black circle symbol was now developed after 10 seconds of exposure.

The opening of the microwave door was then increased until the Broadband Isotropic Radiation Monitor indicated a 5 mW/cm² field. The white line against the black circle symbol was developed after 2 seconds of exposure.

The ambient room temperature was now increased to 90 degrees Fahrenheit and the same experiment previously recited utilizing the 5 mW/cm² field leak was performed. Again, the white line against the black circle symbol was developed after two seconds of exposure.

The opening of the microwave door was again increased until the Broadband Isotropic Radiation Monitor indicated a 10 mW/cm² field. Now the white line against the black circle symbol was developed after less than 1 second of exposure.

### Other Embodiments—Description

### Example 2

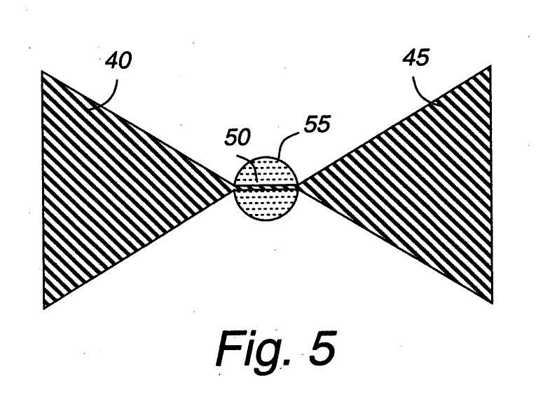

Rather than using a loop antenna, other broad-band antenna embodiments may be used which will enable a single detector to measure leakage from microwave ovens operating at either the 2.45 GHz microwave oven frequency which is authorized for use world-wide, or at the 915 MHz frequency which is authorized for use in North America and South America. There are numerous broad band antenna designs, which could be used for this purpose. Among the most pertinent are the complementary triangular-shaped dipole, plane, and spiral antennas. The complementary triangular-shaped dipole commonly known as the “bow tie” antenna is also known as a Brown-Woodward antenna. It is particularly well suited for this application due to its broad frequency response and simple construction. Referring to FIG. 5, it consists of two triangular-shaped conductive elements 40, 45, which are connected by a narrow resistive element 50. Like the preferred embodiment, these triangular antenna elements and the resistive area can be fabricated by means of metalization, for example, by means of sputtering or by means of hot-stamp foil application. Alternate fabricating means include metal foil, conductive inks and conductive polymers. The conductive inks may comprise silver, copper, carbon, graphite or mixtures thereof. As recited in the Preferred Embodiment, the resistive area 55 is over-coated with a thermochromic ink such that when current flows through the antenna, the resistive area generates heat which in turn causes the thermochromic ink over this area to charge from one color to another color, in this case from black to white. It is also known in the art that other types of color change are readily available such as from a color to colorless, and from colorless to a color. As an alternative to thermochromic ink, thermally responsive liquid crystal materials are also acceptable. The liquid crystal materials may comprise cholesterol oleylcarbonate, cholesterol nanaoate, cholesterol proionate or mixtures thereof.

### CONCLUSIONS, RAMIFICATIONS, AND SCOPE

It has been shown that the present invention provides a device of simple construction, which yet provides an effective, highly sensitive, inexpensive, completely portable and simple means for detecting radiation leakage from microwave ovens. The invention thus fills the need, which has existed in the art of the microwave leakage detectors for high sensitivity, immunity from the effects of ambient temperature, operable by color blind individuals and low in cost.

Clearly various changes may be made in the structure and embodiments shown herein without departing from the concepts of the invention. For example, the thermochromic indicator may be placed on the opposite side of the support member. The resistive area rather than being a line could be in the form of a letter or other symbol. Further, features of the embodiments shown in the various figures may be employed with the embodiments of other figures.

Therefore the scope of the invention is to be determined by the terminology of the following claims and legal equivalence thereof.

I claim as my invention:

1) Means for detecting microwave radiation leakage from a microwave oven, comprising:
a) A support member.
b) An antenna formed on said support layer that has a region of resistive coating capable of being heated by microwave radiation due to current flow through said antenna which includes said resistive region.
c) A temperature sensitive color indicator layer in thermal contact with said resistive region, characterized in that the antenna layer has i.) Is able to effectively collect the microwave radiation leakage from said microwave oven to result in current flow which in turn causes localized heating of its resistive region and ii.) Sufficient heat generating capacity of the resistive region to affect a change in the temperature sensitive, color change indicator layer.

2) A microwave oven leakage detector according to claim 1, wherein the support member is organic.

3) A microwave oven leakage detector as in claim 2, wherein the support member is polystyrene.

4) A microwave oven leakage detector according to claim 1, wherein the support member has a thickness between 8 to 15 mil.

5) The microwave oven leakage detector of claim 1 wherein the color indicator layer is selected from thermochromic inks or liquid crystal materials.

6) The microwave oven leakage detector of claim 1 wherein the antenna layer is formed from hot stamp foil, metal foil, conductive inks or conductive polymers, or by sputtering.

7) The microwave oven leakage detector of claim 5 wherein the conductive inks comprise copper, carbon, graphite or mixtures thereof.

8) The microwave oven leakage detector of claim 1 wherein the color indicator layer changes from:
a) One color to a second color.
b) A color to colorless.
c) Colorless to a color.

9) The microwave oven leakage detector of claim 1 wherein the color indicator layer includes a symbol created by heating of the resistive region to indicate excess microwave oven leakage according to change in its color indicator layer.

10) A test card comprising the microwave oven leakage detector according to claim 1.
